(19) United States
(12) Patent Application Publication
(10) Pub. No.: US 2005/0167135 A1
(43) Pub. Date: Aug. 4, 2005

(54) Electrical panel support stand

(75) Inventor: Todd A. Jackson, Simi Valley, CA (US)

Correspondence Address: KELLY LOWRY & KELLEY, LLP, 6320 CANOGA AVENUE, SUITE 1650, WOODLAND HILLS, CA, 91367, US

(73) Assignee: Anything Electric corporation

(21) Appl. No.: 11/045,932

(22) Filed: Jan. 27, 2005

Related U.S. Application Data
(60) Provisional application No. 60/540,507, filed on Jan. 30, 2004.

(51) Int. Cl. H02G 3/08

(52) U.S. Cl. 174/50

(57) ABSTRACT

An electrical panel support stand includes a base having an aperture for receiving an electrical conduit. A cabinet disposed on the base has a top surface which includes an aperture for providing electro-mechanical connection between the electrical conduit and a first electrical panel associated with the cabinet. In one of the embodiments, a vertical support extends from the top surface of the cabinet and is connected to the first electrical panel.

### RELATED APPLICATION

This application claims the benefit of U.S. Provisional Application No. 60/540,507, filed on Jan. 30, 2004 entitled PANEL SUPPORT STAND.

### BACKGROUND OF THE INVENTION

The present invention relates generally relates to electrical panel support stands. More particularly, the present invention relates to an electrical panel support stand that protects electrical equipment and provides access thereto.

There is a great need for panel supports that allow a user to efficiently support electrical panels as well as provide access to electrical equipment associated therewith.

Many different types of panels have been employed to house electrical equipment and connections. For example, one common style of conventional electrical panel is a generally rectangular compartment for housing electrical equipment, made of sheet metal, attached to a wall of a structure, with knockouts or the like to allow wires to enter and exit the panel. The panel may have a door to allow a user access the contents therein or an access plate that must be unscrewed from the panel in order to provide access to the contents within the panel. However, this panel merely houses the electrical equipment, must be supported by a wall or similar surface, and is subject to corrosion.

While panels such as the one described above may provide means of housing electrical equipment and connections, such devices can always be improved to allow a user to support the panel, and provide access the contents therein while preventing the contents therein from coming into contact with the external environment.

Accordingly, there is a need for a stand-alone panel support stand that supports a panel without needing to connect the panel to a wall of a structure. There is a further need for a panel support stand that provides a user with improved access to the electrical connections to the contents of the panel. There is an additional need for a panel support stand that prevents the contents of the panel or the electrical connections thereto from coming into contact with the external environment. There is a further need for a panel support stand that is economical and easy to manufacture. The present invention satisfies these needs and provides other related advantages.

### SUMMARY OF THE INVENTION

The present invention provides a stand-alone panel support stand that supports a panel without needing to connect the panel to a wall of a structure. The panel support stand disclosed herein provides a user with improved access to the electrical connections and the contents of the panel. The panel support stand described below prevents the contents of the panel and/or the electrical connections thereto from coming into contact with the external environment.

In one embodiment of the present invention, an electrical panel support stand includes a base having an aperture for receiving an electrical conduit. A cabinet disposed on the base has a top surface which includes an aperture for providing electromechanical connection between the electrical conduit and a first electrical panel associated with the cabinet. A vertical support extends from the top surface of the cabinet and is connected to the first electrical panel.

The vertical support shares a common side with the cabinet. A second electrical panel is connected to the vertical support on a side thereof opposite that of the first electrical panel. The vertical support includes a top portion having a plurality of apertures for securing the first electrical panel to the stand. A second electrical panel is electrically connected to the electrical conduit and mechanically connected to the vertical support on a side thereof opposite that of the first electrical panel.

The base and cabinet may be separate components or of unitary construction. In any event, the base and stand are made of UV resistant, corrosive resistant molded plastic.

A divider separates the cabinet into a low voltage wire portion and a high voltage wire portion. The low and high voltage wires from the electrical conduit run through the cabinet to the first electrical panel through the aperture of the top surface of the cabinet. A ground bus is located inside the cabinet for connection to wires passing through the cabinet between the electrical conduit and the electrical panel.

A cabinet cover is removably fixed over a front side of the cabinet and connected thereto by fasteners.

A ground fault receptacle aperture is located on one side of the cabinet. A switch located on the side of the cabinet regulates the flow of electricity between the electrical conduit and the electrical panel.

One side of the cabinet includes at least one knock-out hole for a twist-lock connector providing electrical connection between the electrical panel and a motor. A ground bus is located inside the cabinet for connection to wires passing through the cabinet between the electrical conduit and the electrical panel.

The base includes a plurality of fastening apertures for connecting the base of the stand to a horizontal concrete surface.

The stand is made of UV resistant, corrosive resistant molded plastic.

Steps may be taken to prevent the contents of the panel and/or the electrical connections thereto from coming into contact with the external environment. In this manner, a first rubber gasket is positioned between the concrete surface and the base to provide an environmental seal therebetween. A second rubber gasket is positioned between the cabinet cover and the cabinet to provide an environmental seal therebetween.

In another embodiment of the present invention, an electrical panel support stand includes a base having an aperture for receiving an electrical conduit. A cabinet is disposed on the base and has an accessible front side and a top surface which includes an aperture for providing electro-mechanical connection between the electrical conduit and a first electrical panel associated with the cabinet. A cabinet cover is removably fixed to the front side of the cabinet.

A second electrical panel may be connected to the cabinet. The second electrical panel may also be connected to an interior wall of the cabinet. Low and high voltage wires from the electrical conduit run through the cabinet to the electrical panel through the aperture of the top surface of the cabinet.

A ground fault receptacle aperture is located on one side of the cabinet. Additionally, a switch is located on one side of the cabinet for regulating the flow of electricity between the electrical conduit and the electrical panel. A ground bus is located inside the cabinet for connection to wires passing through the cabinet between the electrical conduit and the electrical panel.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an orthogonal view of a panel support stand embodying the present invention shown supporting a conventional panel;

FIG. 2 is an orthogonal view of a panel support stand embodying the present invention shown supporting a conventional panel and electrical conduits entering the stand from below;

FIG. 3 is a side elevational view of the panel support stand of FIG. 1;

FIG. 4 is a front elevational view of the panel support stand of FIG. 1 shown with a front cover removed;

FIG. 5 is a cut-away view of a portion of the interior of the panel support stand taken along line 5 of FIG. 4;

FIG. 6 is a front elevational view of a panel cover of the panel support stand of FIG. 1;

FIG. 7 is a side elevational view of the panel cover of FIG. 6;

FIG. 8 is a top cross-sectional view of a base of the panel support stand of FIG. 1; and

FIG. 9 is.

### DETAILED DESCRIPTION OF THE PREFERRED EMBODIMENT

The present invention is useful in a variety of ways. The present invention provides support to a panel (e.g., an electrical pool panel in a swimming pool equipment area) where mounting locations are often difficult and unsightly and the panel support stand provides simplified installation and hook up of the electrical system to the pool equipment.

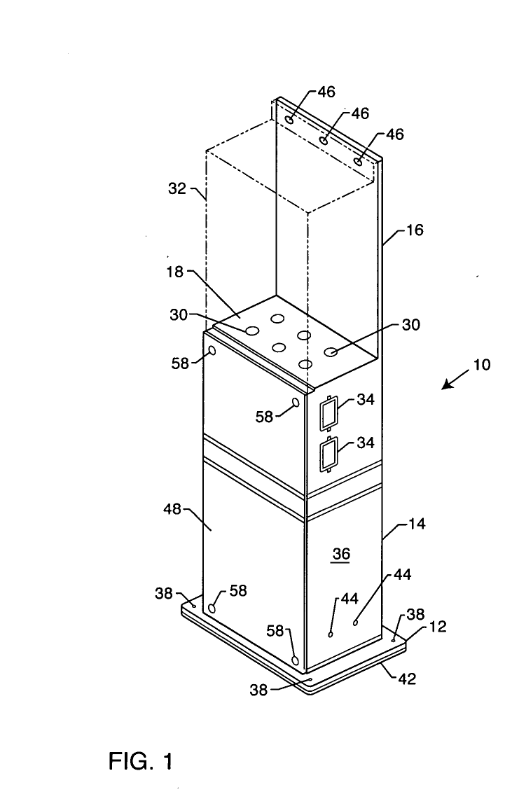

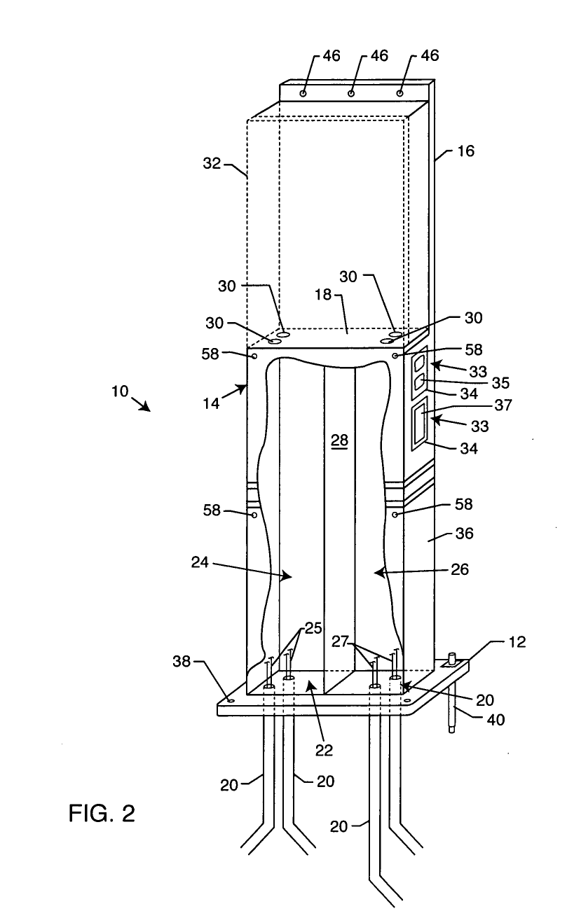

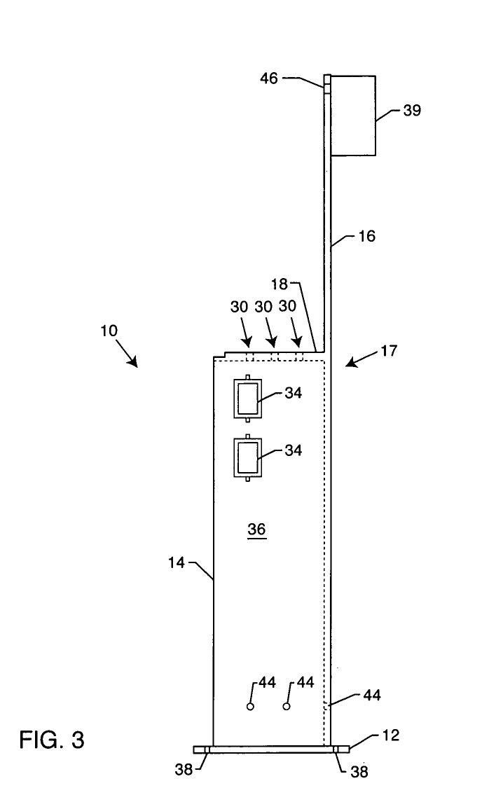

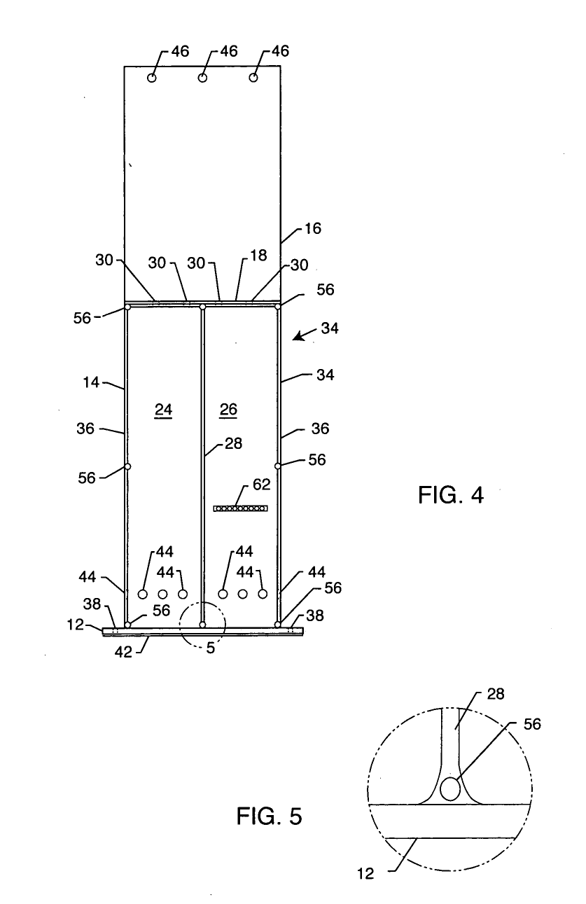

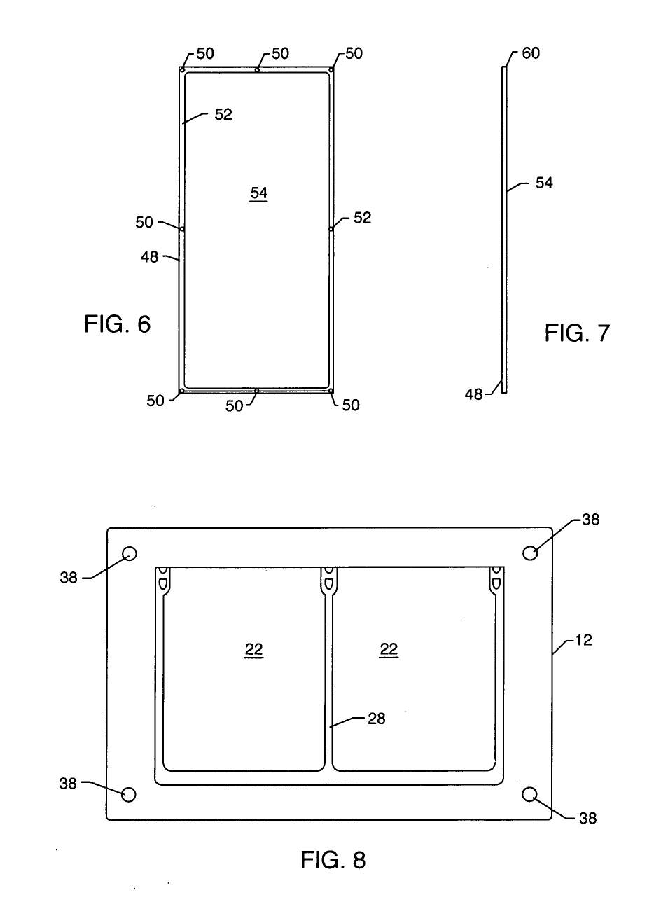

As shown in FIGS. 1-8 for purposes of illustration, the present invention resides in a panel support stand 10. The panel support stand 10 may be made of many materials including, without limitation, plastic (e.g., UV-rated, corrosion-resistant plastic, PVC, or the like), metal (e.g., aluminum, steel), a composite material, any corrosion-resistant material, or the like.

The panel support stand 10 includes a base 12, a wireway pedestal cabinet 14 located atop the base 12, and a panel support back 16 extending upward from a panel support platform (i.e., top side) 18 of the pedestal cabinet 14. The panel support back 16 shares a common side 17 with the cabinet 14. In the alternative, the panel support back 16 may be positioned centrally on the panel support platform 18 such that knock-out holes 30 are on either side of the support back 16. The base 12 and cabinet 14 may be of single-piece construction or made as separate pieces and connected to each other by fasteners, adhesives, welds or the like.

The pedestal cabinet 14 is designed to receive electrical conduits 20 up through a central aperture 22 in the base 12 or, alternatively, a number of knock-out holes (not shown) in the base 12. The cabinet 14 is divided into a low voltage wire portion 24 and a high voltage wire portion 26 by a center panel or divider 28. The low and high voltage wires 25, 27 (only partially shown for clarity) extend from the conduits 20 and run through the interior of the cabinet 14 to the panel support platform 18. A number of 3/4 inch knock-out holes 30 located on the panel support platform 18 provide access into a conventional electrical panel 32 positioned thereon and connected to the panel support back 16.

A number of openings 34 are located on the sides 36 of the stand 10 for electrical devices 33 (e.g., switches 35, ground fault receptacles 37 or the like). The switches 35 may be of several varieties including, without limitation, an on/off switch or the like. Alternatively, an opening for an electrical outlet (not shown) connected to the wires 25, 27 of the conduits 20 may be on the side of the cabinet 14. The base 12, in the form of a 1/4 inch wide flange at the bottom portion of the stand 10, includes a number of holes 38 for fasteners 40 (e.g., 3/8 inch anchor bolts) that connect the stand 10 to a horizontal concrete surface (not shown). A rubber gasket 42 is positioned between the concrete surface and the base 12 to provide a seal. The support back 16 of the stand 10 is also designed to mount additional electrical panels 39 and other units (not shown) including, without limitation low voltage timers, chlorinators, remote control units, etc. that may be electrically connected to wires 25, 27 through knock-out holes 30. The sides 36 of the stand 10 also include knock-out holes 44 for electrical connection of wires 25, 27 to motors and the capability of twist-lock connectors for easy motor hook up. A number of openings 46 are located along a top portion of the panel support back 16 for securing the conventional panels 32, 39 or the like to the stand 10 using fasteners (not shown for clarity).

A cabinet cover 48 is positioned over the front of the pedestal cabinet 14. The cover 48 includes a number of apertures 50 positioned around the perimeter of the cover 48. The cover 48 includes a perimeter flange 52 surrounding a raised portion 54 that extends inwardly towards the cabinet 14 when the cover 48 is in position over the front of the cabinet 14. When the cover 48 is in position, each of the apertures 50 align with a particular bore 56 in the cabinet 14. A fastener 58 (e.g., a screw, nut and bolt, or the like) is inserted through each aligned aperture 50/bore 56 to connect the cover 48 to the cabinet 14. A rubber gasket 60 is positioned around the flange 48 to provide an environmental seal between the cabinet cover 48 and the cabinet 14.

In one embodiment of the present invention, the stand 10 is constructed of UV resistant, corrosive resistant molded plastic; the base 12, pedestal cabinet 14 and support back 16 being of single-piece construction in the form of 1/2 inch thick molded plastic.

A ground bus 62 is located in the interior of the cabinet 14 for connection to various wires that pass through the cabinet 14.

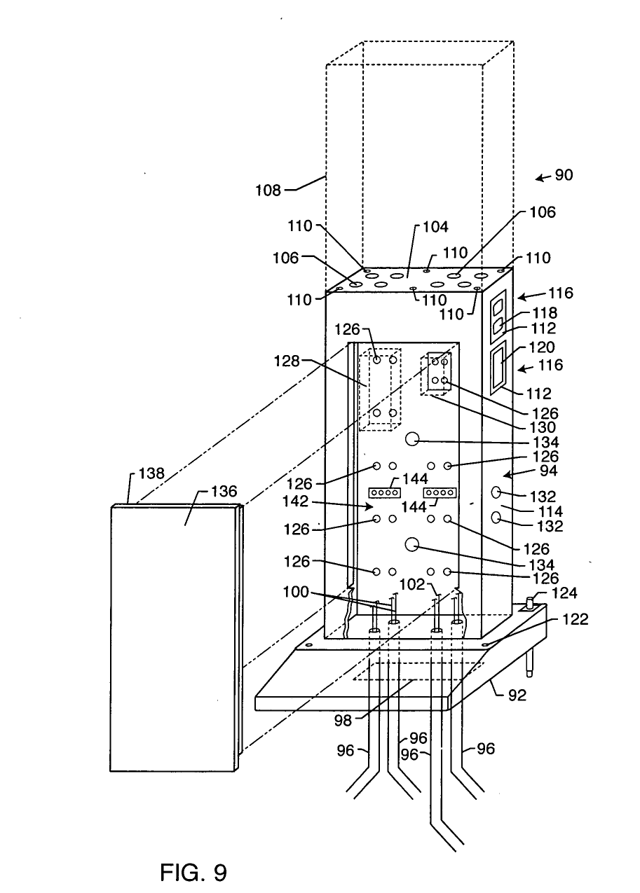

As shown in FIG. 9 for purposes of illustration, the present invention resides in a panel support stand 90 similar to the panel support stand 10 discussed above except that the panel support stand 90 does not include the support back 16. The panel support stand 90 may be made of many materials including, without limitation, plastic (e.g., UV-rated, corrosion-resistant plastic, PVC, or the like), metal (e.g., aluminum, steel), a composite material, any corrosion-resistant material, or the like.

The panel support stand 90 includes a hollow base 92 and a hollow wireway pedestal cabinet 94 located atop the base 92. The base 92 and cabinet 94 may be of single-piece construction or made as separate pieces and connected to each other by fasteners, adhesives, welds or the like.

The pedestal cabinet 94 is designed to receive electrical conduits 96 up through a central aperture 98 in the base 92 or, alternatively, a number of knock-out holes (not shown) in the base 92. Low and high voltage wires 100, 102 (only partially shown for clarity) extend from the conduits 96 and run through the interior of the cabinet 94 to a panel support platform 104 (i.e., a top surface of the cabinet 94). A number of 3/4 inch knock-out holes 106 located on the panel support platform 104 provide access into a conventional electrical panel 108 positioned thereon and connected to the panel support back 16 by fasteners (not shown) inserted through a number of holes 110 on the panel support platform 104. A rubber gasket (not shown) may be positioned between the cabinet 94 and the conventional electrical panel 108 to provide an environmental seal.

A number of openings 112 are located on the sides 114 of the stand 90 for electrical devices 116 (e.g., switches 118, ground fault receptacles 120 or the like). The switches 118 may be of several varieties including, without limitation, an on/off switch or the like. Alternatively, an opening for an electrical outlet (not shown) connected to the wires 100, 102 of the conduits 96 may be on the side of the cabinet 94. The base 92 includes a number of holes 122 for fasteners 124 (e.g., 3/8 inch anchor bolts) that connect the stand 90 to a horizontal concrete surface (not shown). A rubber gasket (not shown) may be positioned between the concrete surface and the base 92 to provide an environmental seal. The interior of the cabinet 94 is also designed to mount (via mounting holes 126) additional electrical panels 128 and other units 130 including, without limitation low voltage timers, chlorinators, remote control units, etc. that may be electrically connected to wires 100, 102. The sides 114 of the stand 90 also include knock-out holes 132 for electrical connection of wires 100, 102 to motors and the capability of twist-lock connectors for easy motor hook up. The sides 114 of the stand 90 additionally include apertures 134 for mechanically connecting (via fasteners (not shown)) the stand 90 to a side of a structure, such as a house, shed, garage or the like in order to provide additional support in maintaining the stand 90 in an upright position.

A cabinet cover 136 is positioned over the front of the pedestal cabinet 94. The cover 136 includes a perimeter flange 138 surrounding a raised portion 140 that extends inwardly towards the cabinet 94. The cover 136 is positioned over an aperture 142 on the front of the cabinet 94 and connected to the cabinet 94 by interference fit with the aperture 142. A rubber gasket (not shown) may be positioned around the flange 138 to provide an environmental seal between the cabinet cover 136 and the cabinet 94. Alternatively, the cover 136 includes a number of apertures (not shown) positioned around the perimeter of the cover 136 When the cover 136 is in position, each of the apertures align with a particular bore in the cabinet 94 around the perimeter of the aperture 142. A fastener (e.g., a screw, nut and bolt, or the like) is inserted through each aligned aperture/bore to connect the cover 136 to the cabinet 94.

In one embodiment of the present invention, the stand 90 is constructed of UV resistant, corrosive resistant molded plastic; the base 92 and pedestal cabinet 94 being of single-piece construction in the form of ½ inch thick molded plastic.

One or more ground buses 144 are located in the interior of the cabinet 94 for connection to various wires that pass through the cabinet 94.

The above-described embodiments of the present invention are illustrative only and not limiting. It will thus be apparent to those skilled in the art that various changes and modifications may be made without departing from this invention in its broader aspects.

1. An electrical panel support stand, comprising:
a base having an aperture for receiving an electrical conduit;
a cabinet disposed on the base, having a top surface which includes an aperture for providing electromechanical connection between the electrical conduit and a first electrical panel associated with the cabinet; and
a vertical support extending from the top surface of the cabinet, and connected to the first electrical panel.

2. The electrical panel support stand of claim 1, wherein the vertical support shares a common side with the cabinet.

3. The electrical panel support stand of claim 1, including a second electrical panel connected to the vertical support on a side thereof opposite that of the first electrical panel.

4. The electrical panel support stand of claim 1, wherein the base and cabinet are of unitary construction.

5. The electrical panel support stand of claim 1, including a divider for separating the cabinet into a low voltage wire portion and a high voltage wire portion, wherein low and high voltage wires from the electrical conduit run through the cabinet to the electrical panel through the aperture of the top surface of the cabinet.

6. The electrical panel support stand of claim 1, including a ground fault receptacle aperture on one side of the cabinet.

7. The electrical panel support stand of claim 1, including a switch on one side of the cabinet for regulating the flow of electricity between the electrical conduit and the electrical panel.

8. The electrical panel support stand of claim 1, including a cabinet cover removably fixed over a front side of the cabinet and connected thereto by fasteners.

9. The electrical panel support stand of claim 1, including a ground bus located inside the cabinet for connection to wires passing through the cabinet between the electrical conduit and the electrical panel.

10. The electrical panel support stand of claim 1, wherein one side of the cabinet includes at least one knock-out hole for a twist-lock connector providing electrical connection between the electrical panel and a motor.

11. The electrical panel support stand of claim 1, wherein the stand is made of UV resistant, corrosive resistant molded plastic.

12. An electrical panel support stand, comprising:
a base having an aperture for receiving an electrical conduit;
a cabinet disposed on the base, having a top surface which includes an aperture for providing electromechanical connection between the electrical conduit and a first electrical panel associated with the cabinet;
a cabinet cover removably fixed over a front side of the cabinet and connected thereto by fasteners;
a divider for separating the cabinet into a low voltage wire portion and a high voltage wire portion, wherein low and high voltage wires from the electrical conduit run through the cabinet to the electrical panel through the aperture of the top surface of the cabinet; and
a vertical support extending from the top surface of the cabinet, connected to the first electrical panel, and sharing a common side with the cabinet.

13. The electrical panel support stand of claim 1, including a second electrical panel connected to the vertical support on a side thereof opposite that of the first electrical panel.

14. The electrical panel support stand of claim 1, wherein the base and cabinet are of unitary construction.

15. The electrical panel support stand of claim 1, including a ground fault receptacle aperture on one side of the cabinet.

16. The electrical panel support stand of claim 1, including a switch one side of the cabinet for regulating the flow of electricity between the electrical conduit and the electrical panel.

17. The electrical panel support stand of claim 1, including a ground bus located inside the cabinet for connection to wires passing through the cabinet between the electrical conduit and the electrical panel.

18. The electrical panel support stand of claim 1, wherein one side of the cabinet include at least one knock-out hole for a twist-lock connector providing electrical connection between the electrical panel and a motor.

19. The electrical panel support stand of claim 1, wherein the stand is made of UV resistant, corrosive resistant molded plastic.

20. An electrical panel support stand, comprising:
a base having an aperture for receiving an electrical conduit and a plurality of fastening apertures for connecting the base to a horizontal concrete surface;
a first rubber gasket positioned between the concrete surface and the base to provide an environmental seal therebetween;
a cabinet disposed on the base, having a top surface which includes an aperture for providing electro-mechanical connection between the electrical conduit and a first electrical panel associated with the cabinet, and at least one knock-out hole for a twist-lock connector providing electrical connection between the first electrical panel and a motor;
a cabinet cover removably fixed over a front side of the cabinet and connected thereto by fasteners;
a second rubber gasket positioned between the cabinet cover and the cabinet to provide an environmental seal therebetween;
a divider for separating the cabinet into a low voltage wire portion and a high voltage wire portion, wherein low and high voltage wires from the electrical conduit run through the cabinet to the electrical panel through the aperture of the top surface of the cabinet;
a vertical support extending from the top surface of the cabinet, connected to the first electrical panel, sharing a common side with the cabinet, and including a top portion having a plurality of apertures for securing the first electrical panel to the stand;
a second electrical panel electrically connected to the electrical conduit and mechanically connected to the vertical support on a side thereof opposite that of the first electrical panel;
a ground fault receptacle aperture on a side of the cabinet;
a switch on a side of the cabinet for regulating the flow of electricity between the electrical conduit and the electrical panel; and
a ground bus located inside the cabinet for connection to wires passing through the cabinet between the electrical conduit and the electrical panel;
wherein the base and cabinet are of unitary construction and made of UV resistant, corrosive resistant molded plastic.

21. An electrical panel support stand, comprising:
a base having an aperture for receiving an electrical conduit;
a cabinet disposed on the base, having an accessible front side and a top surface which includes an aperture for providing electro-mechanical connection between the electrical conduit and a first electrical panel associated with the cabinet; and
a cabinet cover removably fixed to the front side of the cabinet.

22. The electrical panel support stand of claim 21, including a second electrical panel connected to the cabinet.

23. The electrical panel support stand of claim 21, including a second electrical panel connected to an interior wall of the cabinet.

24. The electrical panel support stand of claim 21, wherein low and high voltage wires from the electrical conduit run through the cabinet to the electrical panel through the aperture of the top surface of the cabinet.

25. The electrical panel support stand of claim 24, including a ground fault receptacle aperture on one side of the cabinet, and a switch on one side of the cabinet for regulating the flow of electricity between the electrical conduit and the electrical panel.

26. The electrical panel support stand of claim 21, including a ground bus located inside the cabinet for connection to wires passing through the cabinet between the electrical conduit and the electrical panel.
